(19) United States
(12) Patent Application Publication
(10) Pub. No.: US 2007/0122172 A1
(43) Pub. Date: May 31, 2007

(54) IMAGE FORMING METHOD AND IMAGE FORMING APPARATUS USING THE SAME

(76) Inventors: Joh Ebara, Kanagawa (JP); Yuji Matsuda, Tokyo (JP); Seiichi Handa, Tokyo (JP); Yasuhisa Ehara, Kanagawa (JP); Kazuhiko Kobayashi, Tokyo (JP); Noriaki Funamoto, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/561,085

(22) Filed: Nov. 17, 2006

(30) Foreign Application Priority Data
Nov. 30, 2005 (JP) 2005-346441 (JP)

(51) Int. Cl. G03G 15/043; G03G 15/01; G03G 21/00

(52) U.S. Cl. 399/51; 399/346; 399/350; 399/299

(57) ABSTRACT

An image forming method in which an electrostatic latent image is formed by exposure with an exposure light of light scanning means onto an image carrier charged by charging means, visualization of the electrostatic latent image as a toner image, transfer of the toner image onto a transfer member by application of a bias voltage, and removal of the toner remaining on the image carrier following transfer with a cleaning blade, the exposure being initiated by the light scanning means after a position“a” on the image carrier where said bias voltage has been initiated passes the cleaning blade.

### BACKGROUND OF THE INVENTION

1. Field of the Invention

The present invention relates to an image forming method and an image forming apparatus such as a copier, facsimile device, printer, plotter or combination printer using this image forming method.

2. Description of the Related Art

In conventionally known image forming methods an electrostatic latent image is formed as a result of exposure of an exposure light of light scanning means on an image carrier uniformly charged by charging means, visualizing of the electrostatic latent image as a toner image, transfer of the toner image to a transfer member by application of a bias voltage, and removal of toner remaining on the image carrier following transfer with a cleaning blade. In image forming methods of this kind, the surface electric potential state of the image carrier changes before and after the turning ON of this bias and, when this position (of changed surface electric potential) passes the blade, a load fluctuation that produces a fluctuation in speed of the image carrier is sometimes produced. When writing based on exposure scanning or the like is implemented in the course of a sudden position fluctuation and torque fluctuation of the image carrier, irregularities in toner image density, or color displacement in the case of a color image forming apparatus, are caused by position fluctuations.

On the other hand, image forming belt apparatuses of a configuration in which image forming process means are arranged around a belt spanning between at least two rollers and in which at least one process means acts on a the rollers imparting a rotation load fluctuation are known. Japanese Unexamined Patent Application No. 2001-343843 discloses a technique for avoiding the lowering of image quality on the belt that, in these belt apparatuses, has its origin in the rollers supporting the belt being subjected to load fluctuations caused by contact and separation of a cleaning blade.

However, there is no reference made at all in the technique disclosed in this application to the lowering of image quality of the transfer image that has its origin in the changes in the surface electric potential state of the image carrier that occur before and after the turning ON of the bias and the load fluctuations produced when this position (of changed surface electric potential state) passes the blade.

### SUMMARY OF THE INVENTION

It is an object of the present invention to provide an image forming method in which the lowering of image quality accompanying the application of a transfer bias voltage caused by the sudden load fluctuation that occurs when the position of applied bias on the image carrier passes a blade part in contact with the image carrier can be avoided, and an image forming apparatus in which this method is used.

In an aspect of the present invention, an image forming method comprises the steps of forming an electrostatic latent image by exposure with an exposure light of a light scanning device onto an image carrier charged by a charging device, visualizing the electrostatic latent image as a toner image, transferring the toner image to a transfer member by applying a bias voltage and removing toner remaining on said image carrier following transfer with a cleaning blade. Exposure by the light scanning device is initiated after the position on the image carrier where the application of the bias voltage has been initiated passes the cleaning blade.

In another aspect of the present invention, an image forming apparatus uses an image forming method in which an electrostatic latent image is formed by exposure with an exposure light of a light scanning device onto an image carrier charged by a charging device, the electrostatic latent image is visualized as a toner image, the toner image is transferred to a transfer member by applying a bias voltage, remaining toner is removed from the image carrier following transfer with a cleaning blade, and exposure by said light scanning device is initiated after the position on the image carrier where the application of the bias voltage has been initiated has passes the cleaning blade. The plurality of image carriers are configured as process cartridges in each of which the charging device is integrated.

In another aspect of the present invention, an image forming method comprises the steps of forming an electrostatic latent image by exposure with an exposure light of a light scanning device onto an image carrier charged by a charging device, visualizing the electrostatic latent image as a toner image, transferring the toner image formed on the image carrier to a transfer member by applying a bias voltage and uniformly leveling a lubricant coated on the image carrier using a coating blade. Exposure by the light scanning device is initiated after the position on the image carrier where the application of the bias voltage has been initiated passes the cleaning blade.

In another aspect of the present invention, an image forming apparatus uses an image forming method in which an electrostatic latent image is formed by exposure with an exposure light of a light scanning device onto an image carrier charged by a charging device, the electrostatic latent image is visualized as a toner image, the toner image formed on the image carrier is transferred to a transfer member by applying a bias voltage, a lubricant coated on the image carrier is uniformly leveled using a coating blade, and exposure by the light scanning means is initiated after the position on the image carrier where the application of the bias voltage has been initiated passes the cleaning blade. The plurality of image carrier are configured as process cartridges in each of which the charging device is integrated.

### BRIEF DESCRIPTION OF THE DRAWINGS

The above and other objects, features and advantages of the present invention will become more apparent from the following detailed description based on the accompanying drawings in which:

FIG. 1 is a schematic configuration diagram of an image forming apparatus pertaining to embodiment 1 of the present invention showing an image carrier and process members around the image carrier;

FIG. 2 is a diagram for explaining torque fluctuations and position fluctuations of this image carrier;

FIG. 3 is a schematic configuration diagram of a tandem-type color image forming apparatus pertaining to embodiment 1;

FIG. 4 is a schematic configuration diagram of a process cartridge of this color image forming apparatus;

FIG. 5 is a schematic configuration diagram of an image forming apparatus pertaining to a embodiment 2 of the present invention showing an image carrier and process members around the image carrier; and

FIG. 6 is a diagram for explaining torque fluctuations and position fluctuations of this image carrier.

### DESCRIPTION OF THE PREFERRED EMBODIMENTS

Embodiments of the present invention will be hereinafter described in detail.

### [1] Embodiment 1

### EXAMPLE 1

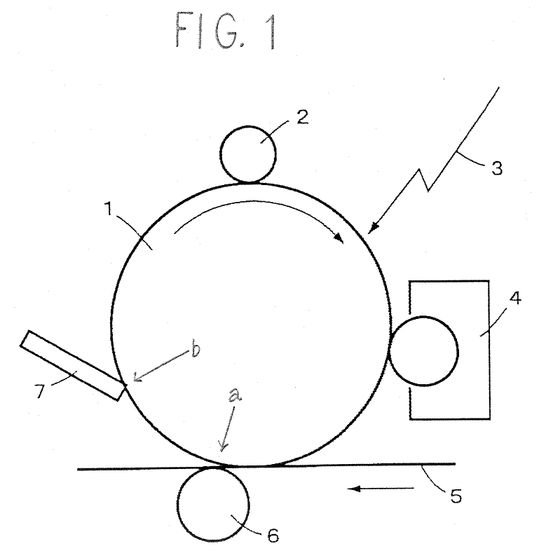

FIG. 1 schematically shows the configuration of an image carrier and process members around the image carrier of an image forming apparatus pertaining to embodiment 1 of the present invention. As shown in the drawing, an image carrier 1 describes a drum shape that, while not shown in the diagram, is rotated in the clockwise direction by a drive motor. The image carrier 1 is charged by a charging roller 2 serving as charging means and, while not shown in the diagram, an exposure light, in this example a laser beam 3, from a writing device serving as light scanning means comprising a laser light source is irradiated onto the image carrier 1 producing an electrostatic latent image. The electrostatic latent image is visualized as a toner image as a result of toner being adhered by a developer apparatus 4. Next, a transfer bias roller 6 for applying a bias voltage applies a bias and the toner image is transferred to a transfer member 5. Following this transfer, in preparation for subsequent image formation, a cleaning blade 7 cleans all the toner remaining on the image carrier 1.

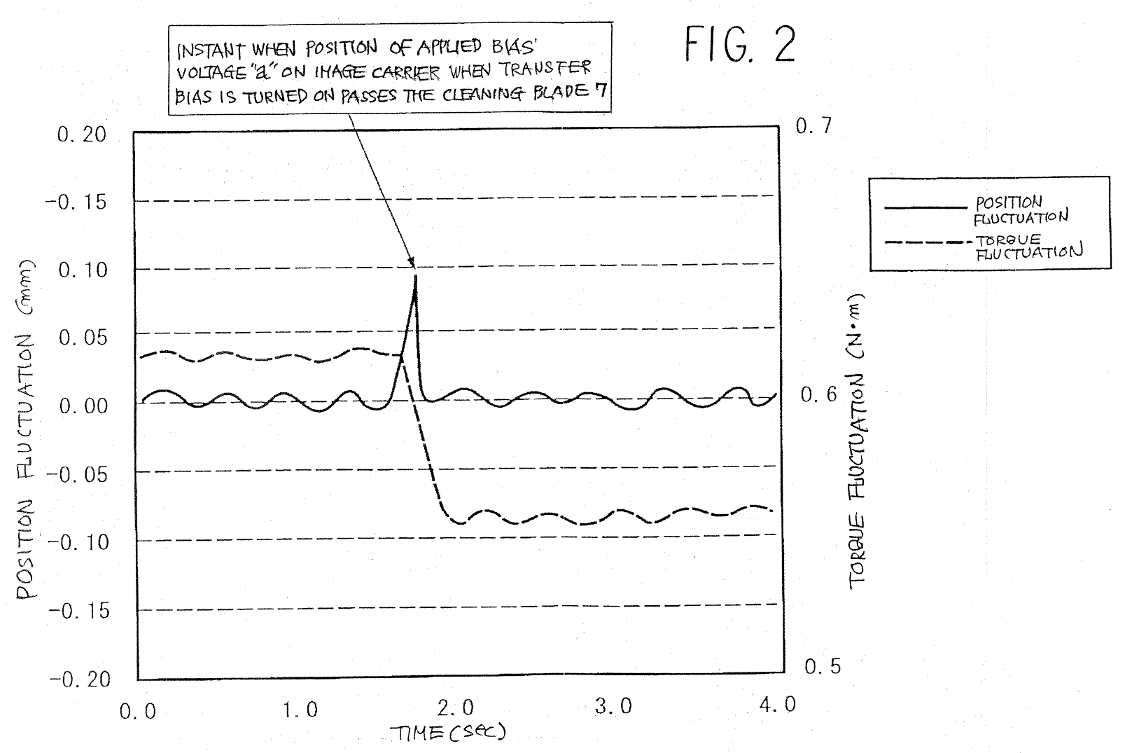

As shown in FIG. 1, taking the position of applied bias voltage on the image carrier 1 when application of the bias voltage on the transfer bias roller 6 is initiated (the instant the transfer bias is turned ON) as “a”, after the position of applied bias voltage “a” moves accompanying the rotation of the image carrier 1 and passes position “b”, in other words, the position at which the cleaning blade 7 comes into contact therewith, an instantaneous decrease in load that causes a fluctuation in speed (position fluctuation) of the image carrier 1 is produced. FIG. 2 shows the details of the load fluctuation and position fluctuation that occur at this time.

As shown in FIG. 2, a position fluctuation peak occurs at the point that the position of applied bias voltage “a” passes the cleaning blade 7 and, in addition, the torque fluctuation suddenly drops after the position of applied bias voltage “a” has passed the cleaning blade 7. While in image forming apparatuses that implement the transfer of toner images in this way the transfer of the toner image to a transfer member normally involves application of bias to the toner image of an image carrier, a change in the surface electric potential state of the image carrier occurs before and after the turning ON of the bias and, when this position (of changed surface electric potential state) passes the blade it causes a fluctuation in speed of the image carrier.

When writing based on exposure scanning or the like is implemented in the course of a sudden position fluctuation and torque fluctuation of the image carrier 1, irregularities in toner image density, or color displacement in the case of a color image forming apparatus, are caused by position fluctuations. In addition, as shown in the diagram, the position fluctuation and torque fluctuation are a temporary phenomenon and a stable state is immediately resumed.

Thereupon, using the image forming method (image forming control) of this embodiment of the present invention, electrostatic latent image disturbance caused by fluctuations in speed of the image carrier can be prevented by initiating irradiation of exposure light of light scanning means, in other words, irradiating a laser beam 3 onto the image carrier 1 after the position of applied bias voltage “a” has passed the cleaning blade 7 and the position fluctuation and torque fluctuation have stabilized.

### EXAMPLE 2

Naturally, the image forming method of example 1 described above is able to have application in image forming methods (apparatuses) that use an indirect transfer system in which the transfer member 5 described in FIG. 1 is a so-called intermediate transfer belt and, after a toner image has been transferred from the image carrier 1 onto the intermediate transfer belt, the toner image is retransferred to a sheet-like member that serves as a final recording material.

### EXAMPLE 3

Naturally, the image forming method of example 1 described above is able to have application in image forming methods (apparatuses) that use a direct transfer system in which the transfer member 5 described in FIG. 1 is a sheet-like medium that serves as a final recording material and the toner image of the image carrier 1 is transferred onto this sheet-like medium.

### EXAMPLE 4

Naturally, the image forming methods (apparatuses) described in example 1 to example 3 above are able to have application in image forming methods (apparatuses) that employ a plurality of image carriers and form color images by superposingly transferring the toner images of the image carriers onto a transfer material.

### EXAMPLE 5

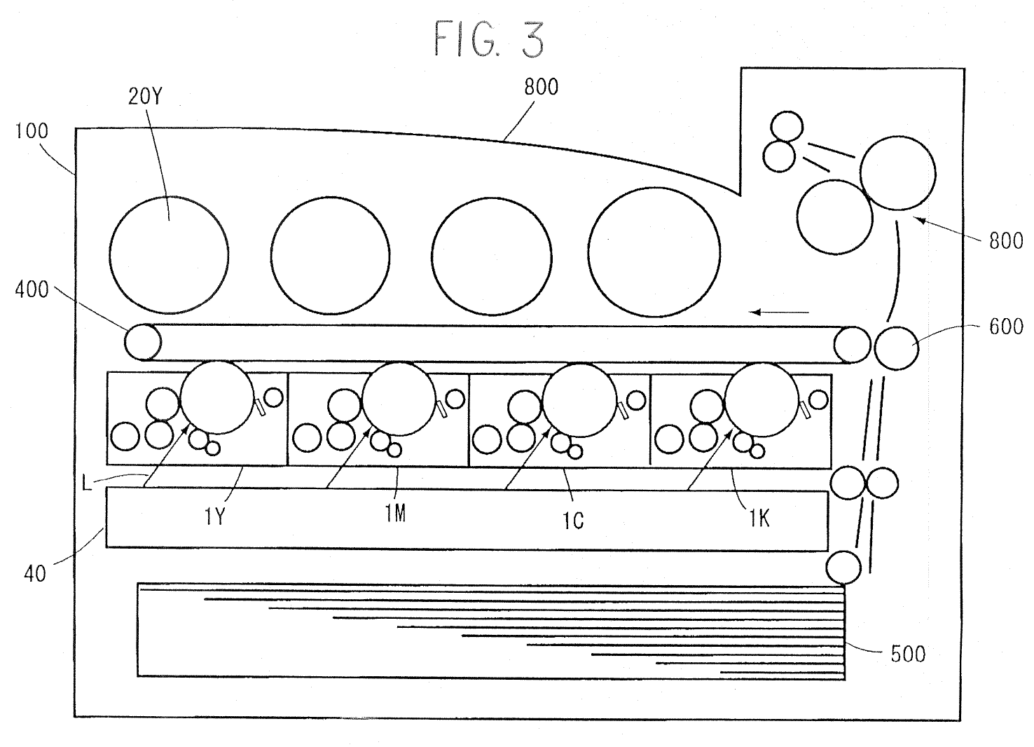

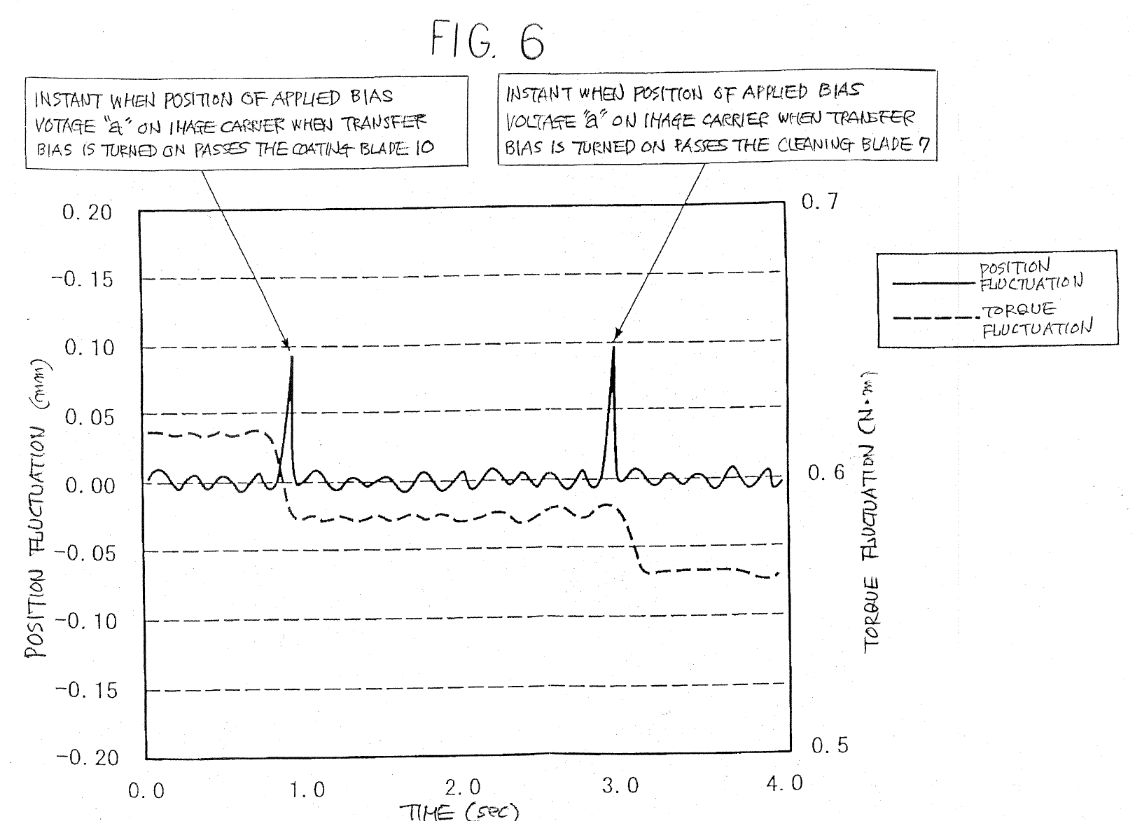

The apparatus shown in FIG. 3 is a tandem-type color image forming apparatus in which the image forming method of example 1 described above has application. Four (a plurality) of image carriers around which processing members such as those shown in FIG. 1 are arranged are employed. FIG. 6 shows an expanded view of the schematic configuration of, of toner image forming units 1Y (for yellow), 1M (for magenta), 1C (for cyan) and 1K (for black) that contain these image carriers, the toner image forming unit 1Y for yellow. The configuration of the other toner image forming units 1M, 1C and 1K is identical to the configuration of this toner image forming unit and, accordingly, the description thereof has been omitted.

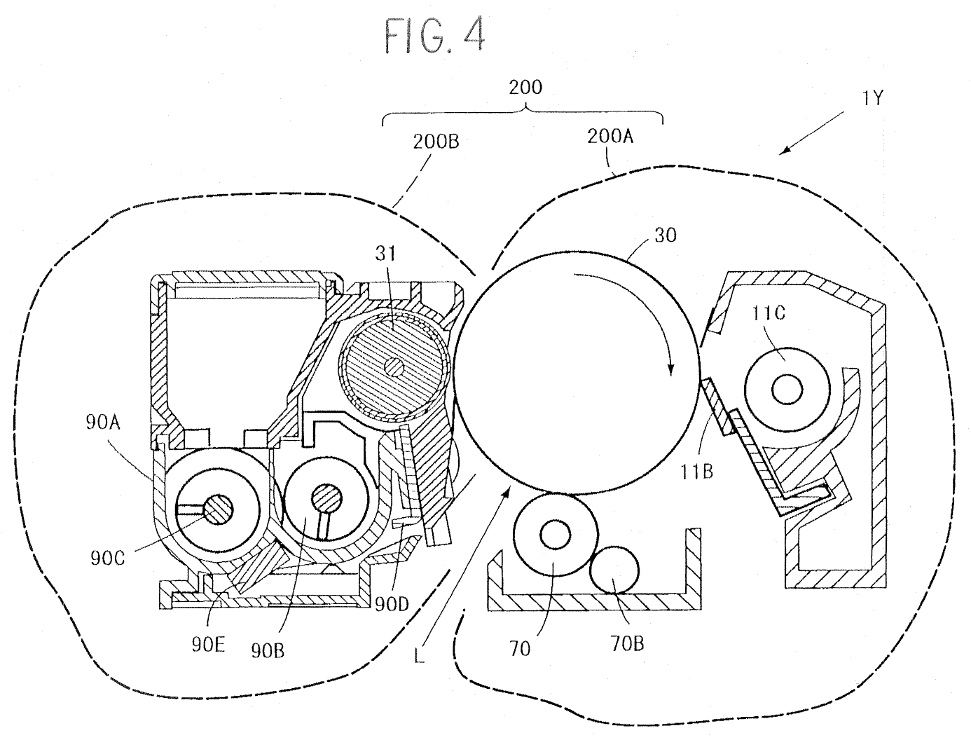

As shown in FIG. 4, a process cartridge 200 comprises a photosensitive unit 200A and a developer unit 200B. The photosensitive unit 200A and developer unit 200B may be formed as an integrated structure. The photosensitive unit 200A is configured to integrally comprise at least a charging roller 70.

The surface of a photosensitive drum 30 serving as the image carrier which is rotated in the clockwise direction is charged to a predetermined electric potential by the charging roller 70 serving as charging means. A cleaning roller 70B for preventing soiling of the surface of the charging roller 70 contacts the charging roller 70 and is rotated to clean the surface thereof.

The photosensitive drum 30 uniformly charged by the charging roller 70 is exposed to a laser beam L serving as an exposure light from an optical unit 40 serving as light scanning means shown in FIG. 3 forming an electrostatic latent image. The developer unit 200B for visualizing the electrostatic latent image comprises a development roller 31 arranged so as to be partially exposed through an opening of a developer case 90A, carrying screws 90C, 90B, development doctor 90D and toner density sensor 90E, and facilitates the supply of toner from a toner housing container 20Y shown in FIG. 3. A two-component developer (hereinafter referred to simply as the developer) containing a magnetic carrier and a minus-charge toner is contained in the developer case 90A.

After being frictionally charged while agitatedly-carried by the carrying screws 90C, 90B, the developer is carried onto the surface of the development roller 31. After regulation of the layer thickness thereof by the development doctor 90D, the developer is carried to a position for development opposing the photosensitive drum 30 where, as a result of the adhering of the toner to the electrostatic latent image on the photosensitive drum 30, the electrostatic latent image is visualized.

In this way, a toner image of a predetermined color (yellow) is formed on the photosensitive drum 30. The developer, the toner thereof having been used in the development process, is returned to the developer case 90A accompanying the rotation of the development roller 31. The toner density of the developer in the developer case 90A is detected by the toner density sensor 90E and, in accordance with need, toner is supplied from the toner housing container 20Y to a space above the screw 90C.

Serving as a reference for attachment/detachment of the process cartridge 200 to the image forming apparatus main body 100 shown in FIG. 3, the process cartridge 200 comprises holes provided in a flange of the two end parts in the axial direction of the photosensitive drum 30 that serve as main positioning reference parts, as well as auxiliary positioning reference parts not shown in the diagram provided in a frame in each of the front side and rear side thereof and, when the photosensitive unit 200A is mounted in the apparatus main body 100, the photosensitive unit 200A is able to be reliably positioned in the predetermined position for mounting by means of linking parts provided between these reference parts and the apparatus main body 100.

As shown in FIG. 3, the photosensitive drum 30 contacts an intermediate transfer belt 400 of a transfer unit arranged thereabove to form a transfer nip that serves as the position for transfer. The toner developed on the photosensitive drum 30 is transferred onto the intermediate transfer belt 400, while the non-transferred toner remaining on the photosensitive drum 30 is removed by a cleaning blade 11B and carried to a housing unit not shown in the drawing by a toner carry auger 11C.

Using a process identical to the process performed by the toner image forming unit 1Y (for yellow), the other toner image forming units form single color toner images that are superposingly transferred in sequence onto the turning intermediate transfer belt 400 for carrying the superposed toner image, the superposed toner image being then batch-transferred by a secondary transfer part 600 to a sheet-like medium supplied from a paper supply unit 500 before, by way of a fixing unit 700, being carried to a discharge paper tray 800.

While the description given above pertains to an indirect transfer system used in tandem-type color laser printer which serves as one example of example 2, this embodiment can also have application in direct transfer systems used in tandem-type color laser printers in which, as an example of example 3, toner images are directly transferred onto a sheet-like medium, or in monochrome laser printers that comprise a single toner image forming unit that employs a black toner. In addition, this embodiment is also able to have application in other image forming apparatuses such as copiers, printers and facsimile devices.

### [2] Embodiment 2

### EXAMPLE 1

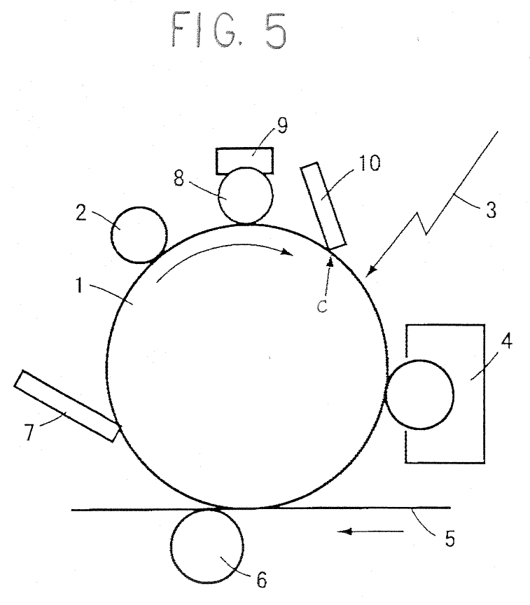

FIG. 5 schematically shows the configuration of an image forming apparatus pertaining to embodiment 2 of the present invention comprising a mechanism for coating a lubricant onto an image carrier 1. A coating roller 8 is arranged on the image carrier 1 in a position between the area where a charging roller 2 is arranged and the area on which a laser beam 3 is irradiated. A solid lubricant 9 contacts the coating roller 8, the lubricant 9 is transferred to the coating roller 8 as a result of the rotation of the coating roller 8 and, thereafter, is coated from the coating roller 8 onto the image carrier 1. The lubricant coated on the image carrier 1 by the coating roller 8 is made uniform and level by a coating blade 10 arranged in contact with the image carrier 1 on the downstream side of the coating roller 8 in the direction of rotation of the image carrier 1. In general, as this lubricant, zinc stearate is widely employed.

In the same way as for the cleaning blade 7 described above, taking the position of applied bias voltage on the image carrier 1 when application of the bias voltage on the transfer bias roller 6 is initiated (the instant the transfer bias is turned ON) as “a”, after the position of applied bias voltage “a” moves accompanying the rotation of the image carrier 1 and passes position “c” shown in the diagram, in other words, the position at which the coating blade 10 comes into contact therewith, an instantaneous decrease in load that causes a fluctuation in speed (position fluctuation) of the image carrier 1 is produced. FIG. 6 shows the details of the load fluctuation and position fluctuation that occur at this time.

As shown in FIG. 6, a position fluctuation peak occurs at the point that the position of applied bias voltage “a” passes the cleaning blade 710 and, in addition, the torque fluctuation suddenly drops after the position of applied bias voltage “a” has passed the coating blade 10. When writing based on exposure scanning or the like is implemented in the course of a sudden position fluctuation and torque fluctuation of the image carrier 1, irregularities in toner image density, or color displacement in the case of a color image forming apparatus, are caused by position fluctuations. In addition, as shown in the diagram, the position fluctuation and torque fluctuation are a temporary phenomenon and a stable state is immediately resumed.

Thereupon, using the image forming method (image forming control) of this embodiment of the present invention, electrostatic latent image disturbance caused by fluctuations in speed of the image carrier can be prevented by initiating irradiation of exposure light of light scanning means, in other words, irradiating a laser beam 3 onto the image carrier 1 after the position of applied bias voltage “a” has passed the coating blade 10 and the position fluctuation and torque fluctuation have stabilized.

In embodiment 2, similarly to embodiment 1 shown in FIG. 5, a cleaning blade 7 is provided around the image carrier 1 and, accordingly, as shown in FIG. 6, because a position fluctuation peak also occurs at the point that the position of applied bias voltage “a” passes the cleaning blade 7 and, in addition, the torque fluctuation suddenly drops after the position of applied bias voltage “a” has passed the cleaning blade 7, irradiation of an exposure light of light scanning means is initiated after the position of applied bias voltage “a” has passed the cleaning blade 7 and the position fluctuation and torque fluctuation have stabilized, and because the position of the cleaning blade 7 is on the upstream side of the coating blade 10 in the direction of rotation of the image carrier 1, by satisfying the exposure initiation conditions described above for the coating blade 10, the exposure initiation conditions specific for the cleaning blade 7 can be simultaneously satisfied.

### EXAMPLE 2

Naturally, the image forming method of example 1 described above is able to have application in image forming methods (apparatuses) that use an indirect transfer system in which the transfer member 5 described in FIG. 1 is a so-called intermediate transfer belt and, following the transfer of a toner image from the image carrier 1 onto the intermediate transfer belt, the toner image is retransferred to a sheet-like member serving as a final recording material.

### EXAMPLE 3

Naturally, the image forming method of example 1 described above is able to have application in image forming methods (apparatuses) that use a direct transfer system in which the transfer member 5 described in FIG. 1 is a sheet-like medium that serves as a final recording material and the toner image of the image carrier 1 is transferred onto this sheet-like medium.

### EXAMPLE 4

Naturally, the image forming methods (apparatuses) described in example 1 to example 3 above are able to have application in image forming methods (apparatuses) that employ a plurality of image carriers and form color images by superposingly transferring the toner images of the image carriers onto a transfer material.

### EXAMPLE 5

The image forming method of the present invention described by example 3 able to have application in an image forming apparatus of a configuration in which the coating roller 8 shown in the diagram is additionally provided around the image carriers of the tandem-type color image forming apparatus described by FIG. 3 that employs four (a plurality) of these image carriers.

In addition, the image forming method of the present invention described by example 3 is able to have application in a configuration in which the coating roller 8 shown in FIG. 5 is additionally provided around the photosensitive drum 30 of the process cartridge 200 described by FIG. 4.

Similarly, this embodiment can also have application in direct transfer systems used in tandem-type color laser printers in which, as an example of example 1, toner images are directly transferred onto a sheet-like medium, or in monochrome laser printers that comprise a single toner image forming unit that employs a black toner. In addition, it is able to have application in other image forming apparatuses such as copiers, printers and facsimile devices.

In embodiments 1 and 2 of the present invention described above, electrostatic latent image disturbance caused by fluctuations in speed of the image carrier can be prevented by this invention by optical writing implemented after the position of applied bias voltage has passed the cleaning blade 7.

Various modifications will become possible for those skilled in the art after receiving the teachings of the present disclosure without departing from the scope thereof.

What is claimed is:

1. An image forming method comprising the steps of:
forming an electrostatic latent image by exposure with an exposure light of light scanning means onto an image carrier charged by charging means;
visualizing the electrostatic latent image as a toner image;
transferring the toner image to a transfer member by applying a bias voltage; and
removing toner remaining on said image carrier following transfer with a cleaning blade,
wherein exposure by said light scanning means is initiated after the position on said image carrier where the application of said bias voltage has been initiated passes said cleaning blade.

2. The image forming method as claimed in claim 1,
wherein an indirect transfer system in which a toner image is transferred onto said transfer member and the toner image is then retransferred onto a sheet-like medium is used.

3. The image forming method as claimed in claim 1,
wherein a direct transfer system in which a toner image is directly transferred onto said transfer member is used.

4. The image forming method as claimed in claim 1,
wherein a plurality of said image carriers are employed.

5. An image forming apparatus which uses an image forming method in which an electrostatic latent image is formed by exposure with an exposure light of light scanning means onto an image carrier charged by charging means, the electrostatic latent image is visualized as a toner image, the toner image is transferred to a transfer member by applying a bias voltage, remaining toner is removed from said image carrier following transfer with a cleaning blade, and exposure by said light scanning means is initiated after the position on said image carrier where the application of said bias voltage has been initiated has passes said cleaning blade,
wherein said plurality of image carriers are configured as process cartridges in each of which said charging means is integrated.

6. An image forming method comprising the steps of:
forming an electrostatic latent image by exposure with an exposure light of light scanning means onto an image carrier charged by charging means;
visualizing the electrostatic latent image as a toner image;
transferring the toner image formed on the image carrier to a transfer member by applying a bias voltage; and
uniformly leveling a lubricant coated on said image carrier using a coating blade;
wherein exposure by said light scanning means is initiated after the position on said image carrier where the application of said bias voltage has been initiated passes said cleaning blade.

7. The image forming method as claimed in claim 6,
wherein an indirect transfer system in which a toner image is transferred onto said transfer member and the toner image is then retransferred onto a sheet-like medium is used.

8. The image forming method as claimed in claim 6,
wherein a direct transfer system in which a toner image is directly transferred onto said transfer member is used.

9. The image forming method as claimed in claim 6,
wherein a plurality of said image carriers are employed.

10. An image forming apparatus which uses an image forming method in which an electrostatic latent image is formed by exposure with an exposure light of light scanning means onto an image carrier charged by charging means, the electrostatic latent image is visualized as a toner image, the toner image formed on the image carrier is transferred to a transfer member by applying a bias voltage, a lubricant coated on said image carrier is uniformly leveled using a coating blade, and exposure by said light scanning means is initiated after the position on said image carrier where the application of said bias voltage has been initiated passes said cleaning blade,
wherein said plurality of image carriers are configured as process cartridges in each of which said charging means is integrated.
